(19) United States
(12) Patent Application Publication
(10) Pub. No.: US 2021/0023636 A1
(43) Pub. Date: Jan. 28, 2021

(54) MITER SAW WITH PIVOTALLY ROTATABLE EXTENSION

(71) Applicant: REXON INDUSTRIAL CORP., LTD., Taichung (TW)

(72) Inventors: Hung Jung CHIANG, Taichung (TW); An Ni CHEN, Taichung (TW)

(73) Assignee: REXON INDUSTRIAL CORP., LTD., Taichung (TW)

(21) Appl. No.: 16/936,460

(22) Filed: Jul. 23, 2020

(30) Foreign Application Priority Data
Jul. 26, 2019 (TW) 108126617

(51) Int. Cl. B23D 45/04; B23D 47/02; B23D 47/12

(52) U.S. Cl. CPC B23D 45/044; B23D 47/04; B23D 47/123; B23D 47/025

(57) ABSTRACT

A miter saw with a pivotally rotatable extension includes a base, a worktable, a cutting member, and an extension member. The base has a pair of lateral edges oppositely extending along a longitudinal direction, a top surface correspondingly engaged to each lateral edge. The worktable is rotatably mounted to the base, and has a work surface corresponding to the top surface. The cutting member is connected to the worktable. The extension member is pivotally mounted to one of the lateral sides of the base. The extension member is convertible between an extended position and a retracted position relative to the base. The extension member has an extension surface. At the extended position, the extension surface is engaged to the top surface longitudinally for supporting a workpiece. At the retracted position, the extension surface is substantially perpendicular to the top surface for minimizing the size of the miter saw.

### FIELD OF THE INVENTION

The present invention relates to a miter saw. More particularly, the present invention relates to a miter saw with a pivotally rotatable extension.

### BACKGROUND OF THE INVENTION

A miter saw according to the prior art (the prior art disclosed in Taiwan patent publication No. 201531352) comprises a base unit, a processing table rotatable relative to the base unit, a sawing unit connected to one side of the processing table, and a pair of fence assemblies fixed to the processing table. The base unit and the processing platform form a workable, and the base unit has a chassis, two feet respectively fixed on two sides of the chassis, two supporting frames respectively penetrating the feet, and two supporting members respectively disposed on outsides of the supporting frames.

When the length of a workpiece to be cut is long, the supporting frames are utilized to drive the supporting members to move outward relative to the base unit, respectively, so that the supporting range can be extended and the workpiece can be stably supported. When packaging and storing are to be carried out, the supporting frames are utilized to respectively drive the supporting members to retract relative to the base unit so as to achieve the purpose of retracting.

In addition, when the current miter saw is temporarily not used and needs to be temporarily stored, the overall volume in the assembled state is large and occupies a large space. Additionally, when the manufacturing of the miter saw is completed and the miter saw is to be packed and transported, it has an increased volume in cubic feet, which increases the transportation cost if it is packaged in the assembled state.

### SUMMARY OF THE INVENTION

One objective of the present invention is to provide a miter saw with a pivotally rotatable extension that can extend in length to support a workpiece and minimize a size of the miter saw.

One aspect of the present invention provides a miter saw with a pivotally rotatable extension comprising a base, a worktable, a cutting member, and an extension member. The base has a pair of lateral edges oppositely extending along a longitudinal direction, and a top surface correspondingly engaged to each of the lateral edges. The worktable is rotatably mounted to the base and has a work surface corresponding to the top surface. The cutting member is connected to the worktable. The extension member is pivotally mounted to the base and adjacent to one of the lateral edges. The extension member is convertible between an extended position and a retracted position relative to the base. The extension member has an extension surface. When the extension member is in the extended position, the extension surface is engaged with one of the top surfaces along the longitudinal direction. When the extension member is in the retracted position, the extension surface intersects the top surface.

One advantage of the present invention is that the convertibility of the extension member between the extended position and the retraced position relative to the base is utilized. When the extension member is in the extended position, the workpiece is supported by the extension surface. When the extension member is in the retracted position, the length of the miter saw along the longitudinal direction can be shortened. Additionally, the size of the miter saw can be minimized, which can reduce the transportation cost.

Numerous objects, features and advantages of the present invention will be readily apparent upon a reading of the following detailed description of various embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a top perspective assembled view of a miter saw with a pivotally rotatable extension according to one embodiment of the present invention;

FIG. 2 is a bottom perspective assembled view of the miter saw with the pivotally rotatable extension according to the embodiment shown in FIG. 1;

FIG. 3 is a partial perspective exploded view of the miter saw with the pivotally rotatable extension according to the embodiment shown in FIG. 1;

FIG. 4 is a partial schematic cross-sectional view of the miter saw with the pivotally rotatable extension according to the embodiment shown in FIG. 1, which illustrates the extension member in an extended position relative to a base;

FIG. 5 is a schematic diagram of an operation of the miter saw with the pivotally rotatable extension according to the embodiment shown in FIG. 1;

FIG. 6 is a schematic diagram showing completion of the operation of the miter saw with the pivotally rotatable extension according to the embodiment shown in FIG. 1, which illustrates the extension member in a retraced position relative to a base;

FIG. 7 is a schematic diagram showing the miter saw in a folded state with the pivotally rotatable extension according to the embodiment shown in FIG. 1;

FIG. 8 is a partially enlarged schematic diagram of FIG. 7; and

FIG. 9 is a schematic diagram showing storage of the miter saw with the pivotally rotatable extension according to the embodiment shown in FIG. 1, which illustrates that the miter saw can stand stably in a folded state.

### DETAILED DESCRIPTION OF PREFERRED EMBODIMENTS

Reference will now be made in detail to different embodiments of the invention, examples of which are illustrated in the accompanying drawings.

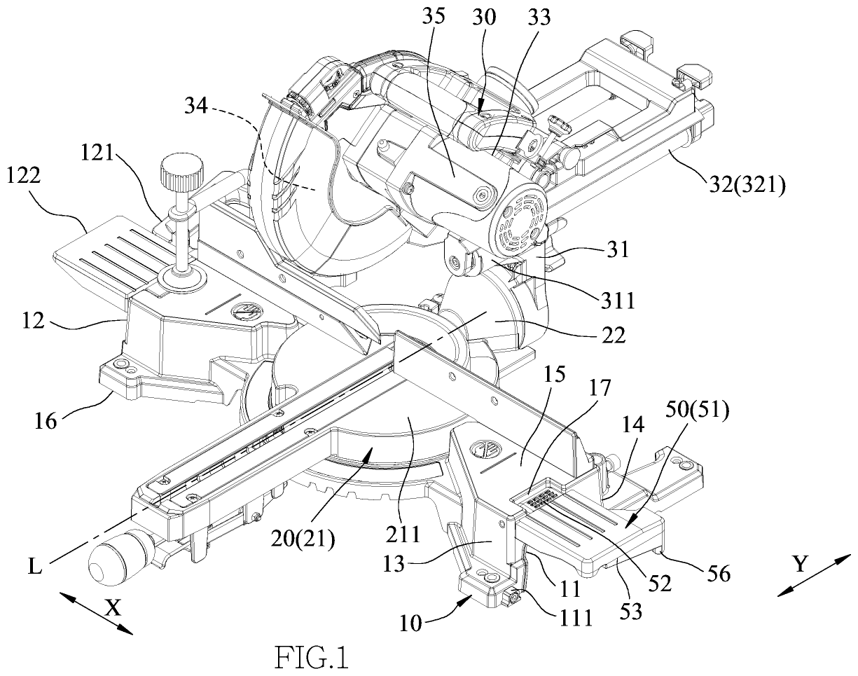

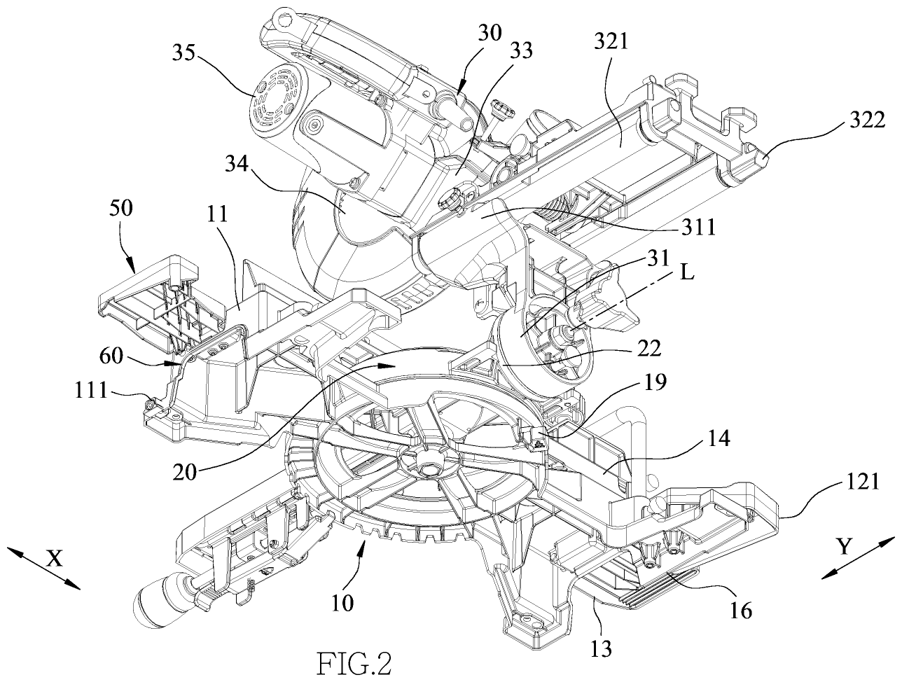

FIG. 1 and FIG. 2 show a miter saw with a pivotally rotatable extension according to one embodiment of the present invention. The miter saw with the pivotally rotatable extension comprises a base 10, a worktable 20, a cutting member 30, an elastic member 40, an extension member 50, and an adjusting screw 60.

The base 10 has a pair of lateral edges 11, 12 oppositely extending along a longitudinal direction X from the worktable 20, a front side edge 13 connected to the lateral edges 11, 12, a rear side edge 14 opposite to the front side edge 13 extending along the longitudinal direction X, the rear side edge 14 disposed opposite to the front side edge 13 along a transverse direction Y perpendicular to the longitudinal direction X, a top surface 15 correspondingly engaged with each of the lateral edges 11, 12, a bottom surface 16 opposite to the top surface 15, a groove 17 recessed on the top surface 15 and communicating with the lateral edge 11, a shaft 18 extending along the transverse direction Y and passing through the groove 17, and a limit block 19 fixed to the bottom surface 16. The lateral edge 11 has a first foot 111, and the other lateral edge 12 is mounted with a carrying handle 121 and locked with a fixed wing 122. The groove 17 is jointly defined by a groove side surface 171 intersecting the top surface 15, a groove bottom surface 172 intersecting the side surface 171 and spaced apart from the top surface 15, and a pair of groove end surfaces 173 intersecting the groove side surface 171 and the groove bottom surface 172 and connected between the groove side surface 171 and the groove bottom surface 172. Each of the groove end surfaces 173 has a pivot portion 174 in a shape of a hole and through which the shaft 18 passes. The pivot portion 174 is formed along a center line L1. The limit block 19 is adjacent to the rear side edge 14.

The worktable 20 is rotatably mounted to the base 10, and has a disk member 21 and an axle seat 22 corresponding to the rear side edge 14 and connected to the disk member 21. The disk member 21 has a work surface 211 corresponding to the top surface 15. The axle seat 22 has an axis L in parallel with the work surface 211 and extends from a position near the rear side edge 14 towards a position near the front side edge 13.

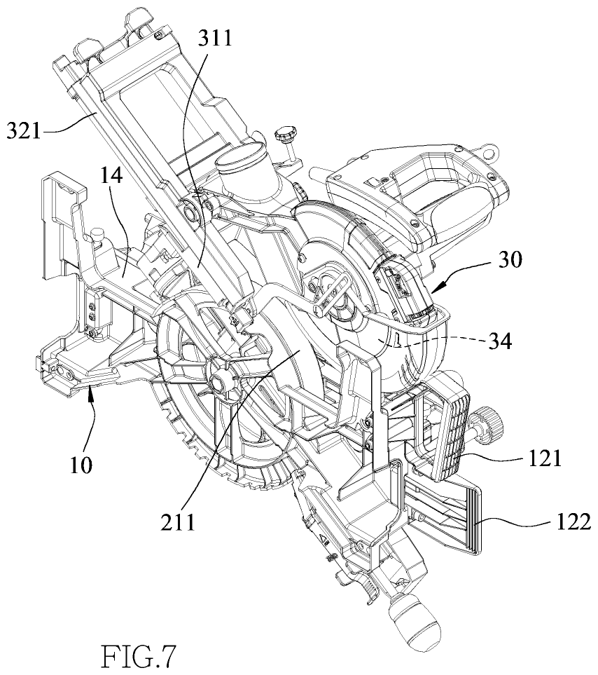

The cutting member 30 has a support base 31 pivotally disposed on the axle seat 22 and capable of rotating relative to the base 10 and the worktable 20, a guide base 32 slidably sleeved on the support base 31, a cantilever 33 pivotally connected to the guide base 32, a saw blade 34 mounted to the cantilever 33, and an actuator 35 mounted to the cantilever 33 and used for driving the saw blade 34 to rotate, e.g., operating the motor. The support base 31 has a sliding guide member 311 for sliding the guide base 32. The guide base 32 has a guide member 321 that can slide relative to the sliding guide member 311 and a second foot 322 disposed at an end of the guide member 321. The cutting member 30 can be rotated with respect to the base 10 and the worktable 20 with the axis L as a center of rotation, and allows the cutting member 30 to be positioned in a working state, e.g., operation position, (see FIG. 1) or a folded state (see FIG. 7). In the working state, a working angle from a substantially perpendicular angle of 90 degrees to 45 degrees is formed between the saw blade 34 and the worktable 20. In the folded state, an end surface of the saw blade 34 approaches the work surface 211, and the sliding guide member 311 and the guide member 321 approach the work surface 211 (see FIG. 7).

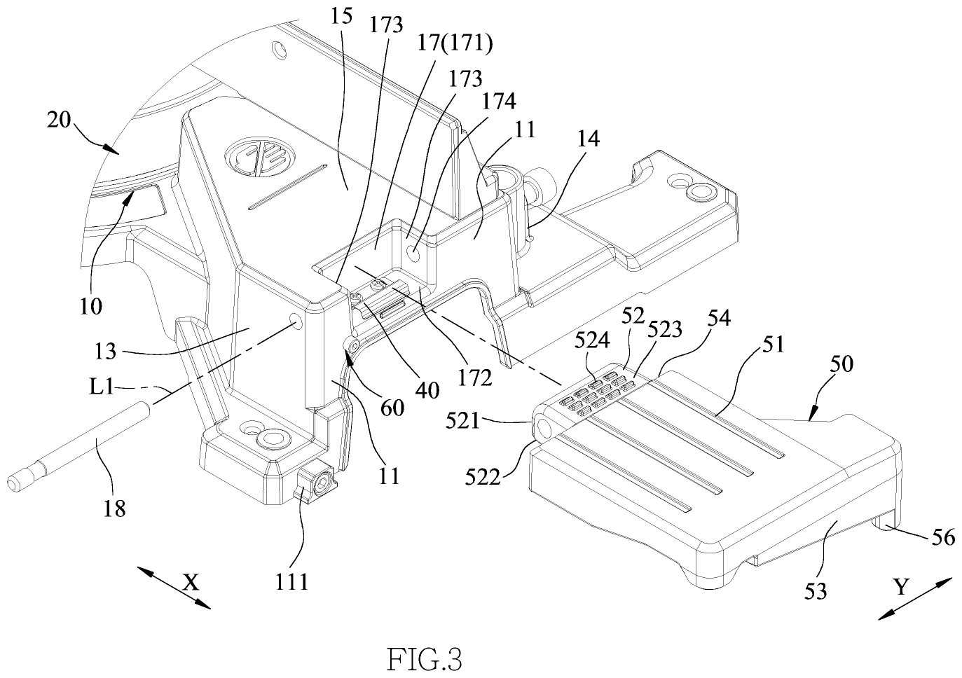

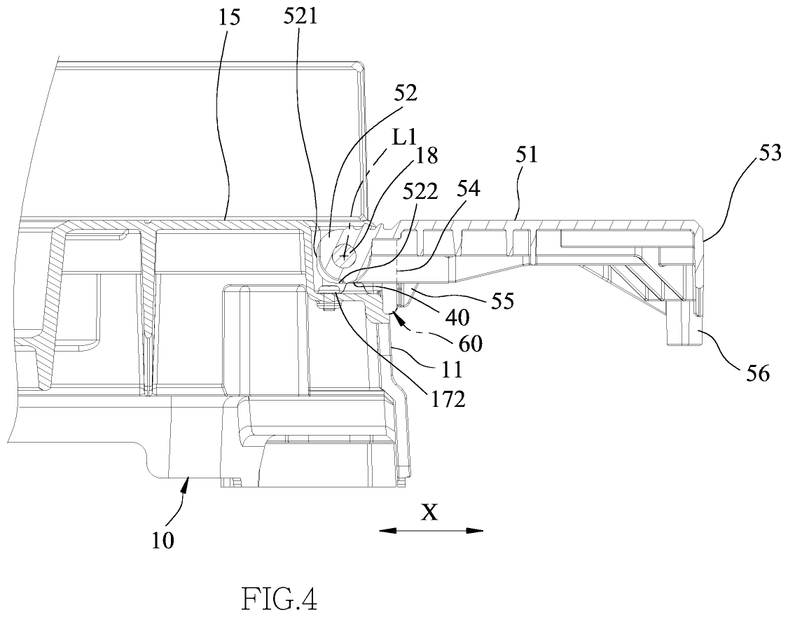

FIG. 3 and FIG. 4 show that the elastic member 40 is formed by adopting a metal reed, and is mounted on the groove bottom surface 172. A position of the elastic member 40 is located between the center line L1 of the pivot portion 174 and the lateral edge 11.

The extension member 50 is pivotally mounted to the base 10 and is adjacent to the lateral edge 11. The extension member 50 according to the present embodiment is pivotally connected in the groove 17. The extension member 50 has an extension surface 51, a pivoting end 52 corresponding to one end of the extension surface 51 and pivoting to the shaft 18, an end portion 53 opposite to the pivoting end 52 and corresponding to another end of the extension surface 51, a shoulder portion 54 between the pivoting end 52 and the end portion 53 and approaching the pivoting end 52, a stopper 55 disposed on the shoulder portion 54, and a third foot 56 disposed on the end portion 53. A width of the pivoting end 52 extending along the transverse direction Y is smaller than that of the end portion 53. The pivoting end 52 has a side surface 521 intersecting the extension surface 51, a bottom surface 522 intersecting the side surface 521 and opposite to the extension surface 51, a top surface 523 opposite to the bottom surface 522, and a plurality of protrusions 524 protruding from the top surface 523. The stopper 55 protrudes from the bottom surface 522 toward an outside opposite to the extension surface 51, and the third foot 56 also protrudes from the bottom surface 522 toward the outside opposite to the extension surface 51.

The adjusting screw 60 is adjustably screwed on the lateral edge 11 and located on one side of the groove 17.

In order to further understand the effect generated by the cooperation of the components of the present invention, the technical means, and the expected effect, a description is provided as follows. It is believed that a more in-depth and detailed understanding of the present invention can be achieved.

As shown in FIG. 1 and FIG. 2, which show the completed assembly of the miter saw in the working state, the actuator, e.g., driver, 35 is suspended above the work surface 211 of the worktable 20. When the workpiece (not shown in the figure) to be cut is positioned on the work surface 211, the extension member 50 and the fixed wing 122 can be utilized to provide a larger supporting length to the workpiece. In addition, the cantilever 33 of the cutting member 30 is operated to drive the saw blade 34 and the guide base 32 is allowed to slide along the support base 31, so that the purpose of sawing the workpiece can be achieved.

As shown in FIG. 4, the extension member 50 is at an extended position and can support the workpiece. At this time, the shoulder portion 54 is opposite to the lateral edge 11, and the extension surface 51 is engaged with the top surface 15 along the longitudinal direction X. The bottom surface 522 is opposite to the groove bottom surface 172. The elastic member 40 is engaged against the bottom surface 522, and the stopper 55 is used to resist against movement of the adjusting screw 60. Additionally, the adjusting screw 60 can be used to adjust the level of the extension surface 51 through screwing in or out the adjusting screw 60 relative the lateral edge 11 to make it more level with the top surface 15, if necessary.

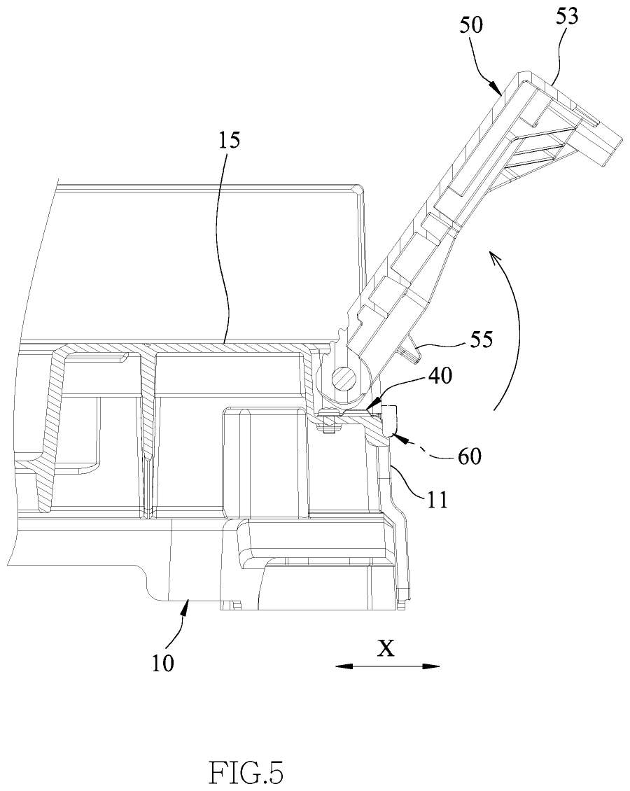

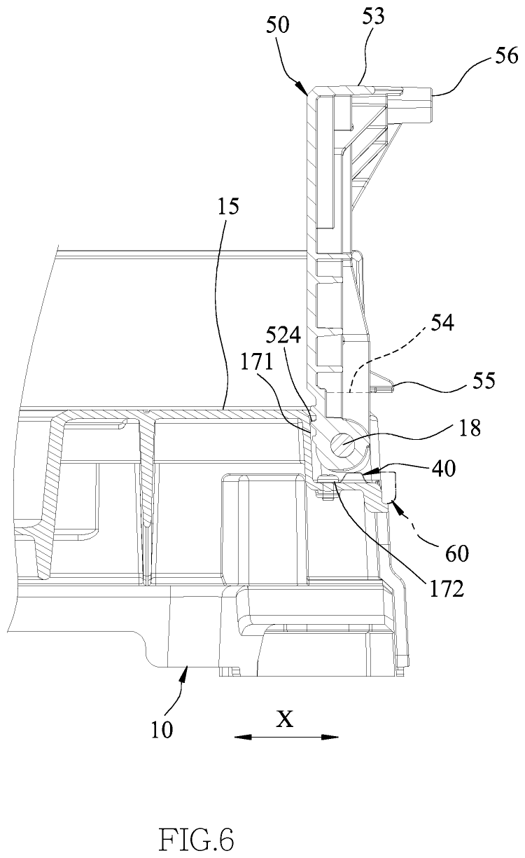

When the miter saw is temporarily not used and needs to be stored or packed and transported, an operator can operate the extension member 50 first to convert it from the extended position of FIG. 4 to a retracted position (as shown in FIG. 5 to FIG. 6). During the retracting operation of the extension member 50 (see FIG. 5), the shaft 18 is used as a pivot center to rotate, and the elastic member 40 is slightly deformed by the squeezing of the pivoting end 52. When the extension member 50 is operated to the retracted position (see FIG. 6), the shoulder portion 54 opposes the top surface 15 and the extension surface 51 is substantially perpendicular to and intersects the top surface 15. At this time, by disposing the elastic member 40 between the center line L1 of the pivot portion 174 and the lateral edge 11, the elastic force of the elastic member 40 can spring against the side surface 521 adjacent to the bottom surface 522, which ensures that the extension member 50 in the retracted position does not easily rotate toward the extended position. Under this circumstance, the protrusions 524 can abut against the groove side surface 171 to ensure that the extension member 50 remains substantially perpendicular to the top surface 15, which reduces a length of the miter saw extending along the longitudinal direction X. In addition to that, the size of the miter saw can be minimized so that the transportation cost can be reduced.

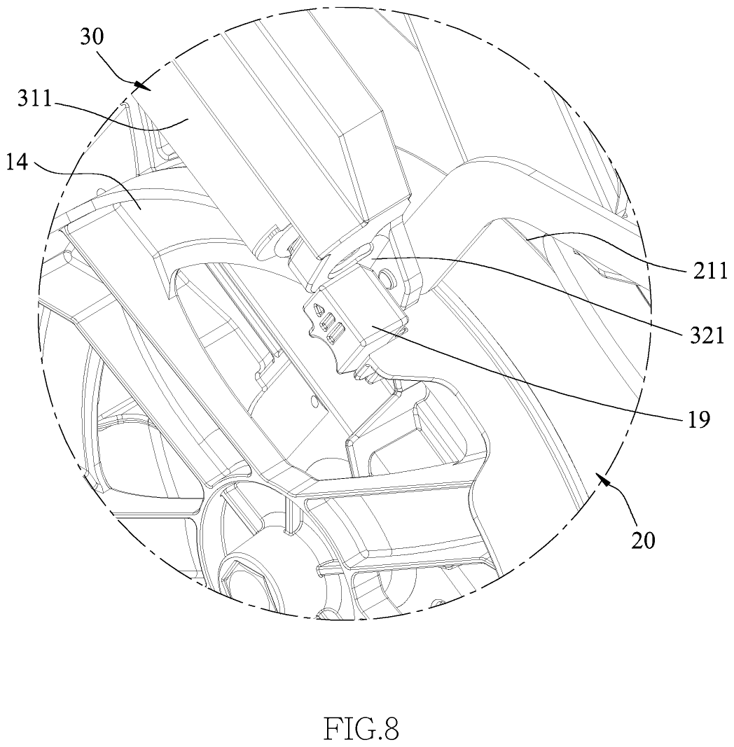

After that, the operator operates the worktable 20 and the cutting member 30 with respect to the base 10 and rotates them toward the left side of FIG. 1 by 45 degrees. Then, the operator operates the support base 31 to rotate relative to the axle seat 22, and the support base 31 is able to be rotated so that the entire cutting member 30 is rotated relative to the worktable 20 with the axis L as the center of rotation until the saw blade 34 rotates and moves to an outside of the rear side edge 14. In addition, when the saw blade 34 is substantially in parallel with the work surface 211, the cutting member 30 is in a folded state (see FIG. 7). At this time, as shown in FIG. 8, the folded cutting member 30 can be provided with better supportability by using an inner end of the guide member 321 to abut the limit block 19 (see FIG. 8).

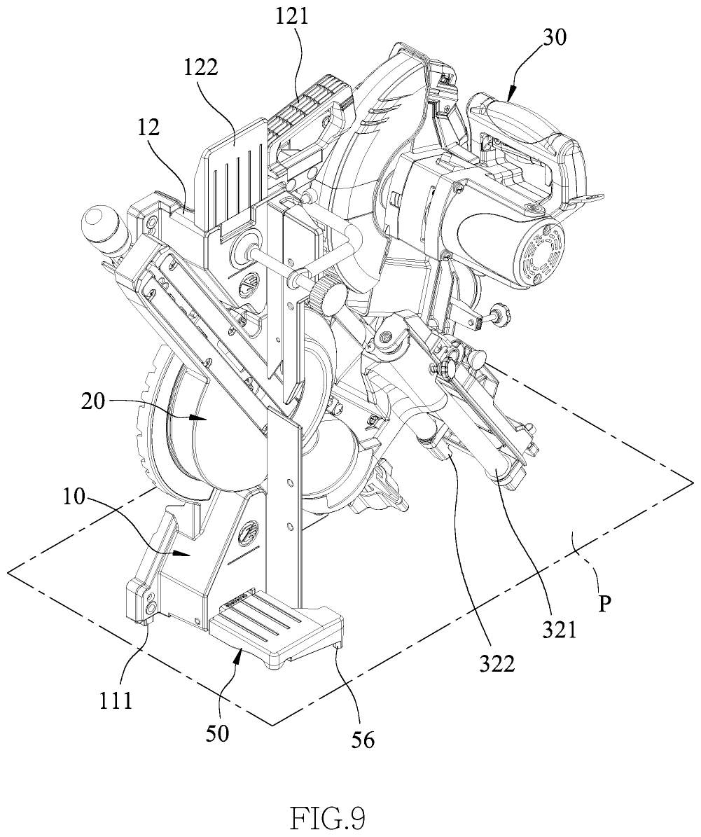

As shown in FIG. 9, when the cutting member 30 is in the folded state, the first foot 111 of the base 10, the second foot 322 at an end of the guide member 321, and the third foot 56 of the extension member 50 together form a positioning plane P, which allows the miter saw to be placed upright on the ground. Additionally, a bottom area of the miter saw when being placed upright is increased, which can ensure a stable positioning when the miter saw is stored. In addition to that, the miter saw can be stored in a small space, which is advantageous to the space usage.

At this time, the lateral edge 12, the carrying handle 121, and the fixed wing 122 are disposed upward. Using the carrying handle 121 can facilitate the user to carry and move. It is worth mentioning that the carrying handle 121 can also be integrated with the fixed wing 122 (not shown), for instance, the fixed wing 122 may have a slot defined such that the fixed wing 122 is configured as a support for workpiece during operation, and a carrying handle for carrying the miter saw.

Therefore, using the extension member 50 to be pivotally mounted to the base 10 and allowing the extension member 50 to be convertible between the extended position and the retraced position relative to the base 10, the workpiece can be supported and the retraction can be performed where appropriate to shorten the length of the base 10 corresponding to the longitudinal direction X. In addition, the first foot 111 of the base 10, the second foot 322 at the end of the guide member 321, and the third foot 56 of the extension member 50 at a folded position are also utilized to cooperate with one another, which can allow the cutting member 30 to be in the folded state to be placed upright on the ground. In so doing the general use is very convenient.

In summary, the miter saw with the pivotally rotatable extension, e.g., extension member, according to the present invention utilizes the convertibility of the extension member 50 between the extended position and the retracted position relative to the base 10, so that the extension member can be extended to support the workpiece or retraced to shorten the length of the miter saw along the longitudinal direction X where appropriate. Additionally, the size of the miter saw can be minimized, which can reduce the transportation cost to indeed achieve the objective of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures. For example, the extension member can be also used in place of the fixed wing 122 to provide further operability and advantages.

What is claimed is:

1. A miter saw with a pivotally rotatable extension comprising:
a base having a pair of lateral edges oppositely extending along a longitudinal direction, and a top surface correspondingly engaged to each of the lateral edges;
a worktable rotatably mounted to the base and having a work surface corresponding to the top surfaces;
a cutting member connected to the worktable; and
an extension member pivotally mounted to the base and adjacent to one of the lateral edges, the extension member being convertible between an extended position and a retracted position relative to the base, the extension member having an extension surface,
wherein when the extension member is in the extended position, the extension surface is engaged with the top surface along the longitudinal direction, and when the extension member is in the retracted position, the extension surface is positioned to intersect the top surface.

2. The miter saw with the pivotally rotatable extension of claim 1, wherein the base further comprises a groove recessed from the top surface and communicating with the one of the lateral edges, wherein the groove is jointly defined by a groove side surface intersecting the top surface, a groove bottom surface intersecting the side surface and spaced apart from the top surface, and a pair of groove end surfaces intersecting the groove side surface and the groove bottom surface and connected between the groove side surface and the groove bottom surface, each of the groove end surfaces having a pivot portion, the extension member having a pivoting end corresponding to one end of the extension surface and pivots with the pivoting portions, and an end portion opposite to the pivoting end.

3. The miter saw with the pivotally rotatable extension of claim 2 further comprising an elastic member mounted on the groove bottom surface, wherein the pivoting end of the extension member has a side surface intersecting the extension surface, a bottom surface intersecting the side surface and disposed opposite to the extension surface, wherein the elastic member engages against the bottom surface when the extension member is in the extended position, and the elastic member springs against the side surface when the extension member is in the retracted position.

4. The miter saw with the pivotally rotatable extension of claim 3, wherein the extension member further comprises a shoulder portion between the pivoting end and the end portion and approaching the pivoting end, a width of the pivoting end extending along a transverse direction perpendicular to the longitudinal direction is smaller than a width of the extension member, the shoulder portion is opposite to the one of the lateral edges when the extension member is in the extended position, and the shoulder position is opposed to the top surface when the extension member is in the retracted position.

5. The miter saw with the pivotally rotatable extension of claim 4 further comprising an adjusting screw adjustable screwed on one of the lateral edges, the extension member having a stopper disposed on the shoulder portion, the stopper being configured to abut against the adjusting screw when the extension member is in the extended position.

6. The miter saw with the pivotally rotatable extension of claim 3, wherein the elastic member is located between a center line of the pivot portion and the lateral edge.

7. A miter saw with a pivotally rotatable extension comprising:
a base having a pair of lateral edges oppositely extending along a longitudinal direction, and a top surface correspondingly engaged to each of the lateral edges;
a worktable rotatably mounted to the base and having a work surface corresponding to the top surface;
an axle seat connected to the worktable, the axle seat having an axis that is parallel with the work surface;
a cutting member connected to the worktable, the cutting member has a support base pivotally disposed on the axle seat of the worktable and is able to rotate relative to the base and the worktable with the axis as a center of rotation, and allows the worktable and the cutting member to be operated from a working state to a folded state, a cantilever pivotally connected to the support base, a saw blade mounted to the cantilever, and an actuator mounted to the cantilever and used for driving the saw blade to rotate, said saw blade defining two opposing end faces; and
an extension member pivotally mounted to the base and adjacent to one of the lateral edges, the extension member being convertible between an extended position and a retracted position relative to the base, the extension member having an extension surface;
wherein in the working state, a working angle from a substantially perpendicular angle of 90 degrees to 45 degrees is formed between the saw blade of the cutting member and the worktable, and the extension member is in the extended position for supporting the workpiece; in the folded state, an end face of said saw blade of said cutting unit is disposed in proximity to said working surface, and the extension member is converted to a retracted position, such that when the cutting member is in the folded state and the extension member is in the retracted position, one of the lateral edges of the base, one end of the support base, and an end portion of the extension member form a positioning plane for allowing the miter saw to be placed upright on the ground.

8. The miter saw with the pivotally rotatable extension of claim 7, wherein the one of the lateral edges of the base has a first foot, one end of the support base has a second foot, the end portion of the extension member has a third foot, wherein when the cutting member is in the folded state and the extension member is in the retracted position, the first foot, the second foot, and the third foot together form a positioning plane.

9. The miter saw with the pivotally rotatable extension of claim 7, wherein the base further comprises a groove recessed from the top surface and communicating with the one of the lateral edges, wherein the groove is jointly defined by a groove side surface intersecting the top surface, a groove bottom surface intersecting the side surface and spaced apart from the top surface, and a pair of groove end surfaces intersecting the groove side surface and the groove bottom surface and connected between the groove side surface and the groove bottom surface, each of the groove end surfaces having a pivot portion, the extension member having a pivoting end corresponding to one end of the extension surface and pivots with the pivoting portions, and an end portion opposite to the pivoting end.

10. The miter saw with the pivotally rotatable extension of claim 9 further comprising an elastic member mounted on the groove bottom surface, wherein the pivoting end of the extension member has a side surface intersecting the extension surface, a bottom surface intersecting the side surface and disposed opposite to the extension surface, wherein the elastic member engages against the bottom surface when the extension member is in the extended position, and the elastic member springs against the side surface when the extension member is in the retracted position.

11. The miter saw with the pivotally rotatable extension of claim 10, wherein the extension member further comprises a shoulder portion between the pivoting end and the end portion and approaching the pivoting end, a width of the pivoting end extending along a transverse direction perpendicular to the longitudinal direction is smaller than a width of the extension member, the shoulder portion is opposite to the one of the lateral edges when the extension member is in the extended position, and the shoulder position is opposed to the top surface when the extension member is in the retracted position.

12. The miter saw with the pivotally rotatable extension of claim 11 further comprising an adjusting screw adjustable screwed on one of the lateral edges, the extension member having a stopper disposed on the shoulder portion, the stopper being configured to abut against the adjusting screw when the extension member is in the extended position.

13. The miter saw with the pivotally rotatable extension of claim 10, wherein the elastic member is located between a center line of the pivot portion and the lateral edge.
